(19) United States
(12) Patent Application Publication
(10) Pub. No.: US 2015/0201593 A1
(43) Pub. Date: Jul. 23, 2015

(54) Chaser Fishing Lure Enhancement

(71) Applicant: Chris Prantl, Bessemer, AL (US)

(72) Inventor: Chris Prantl, Bessemer, AL (US)

(21) Appl. No.: 14/588,978

(22) Filed: Jan. 4, 2015

Related U.S. Application Data
(60) Provisional application No. 61/923,658, filed on Jan. 4, 2014.

(51) Int. Cl. A01K 85/18; A01K 85/16; A01K 85/10; A01K 85/00

(52) U.S. Cl. CPC A01K 85/18; A01K 85/00; A01K 85/16; A01K 85/10

(57) ABSTRACT

A fishing lure and fishing lure enhancement that mimics a larger baitfish chasing smaller baitfish that is calculated to elicit a strike response comprising a central wire shaft with a connection loop to a fish line and chaser wires that terminate into baitfish imitators. The central wire shaft and chaser wires can be permanently installed into a fishing lure or can be formed separate and apart from a fishing lure and made to be attachable and detachable to a wide variety of commercially available fishing lures. The chaser wires and the baitfish imitators located thereon are allowed to move free and independent of a pulling force with the chaser wires surrounding the central wire shaft and causing the baitfish imitators to appear as a small school of baitfish.

### CROSS-REFERENCE TO RELATED APPLICATIONS

This application claims the benefit of priority to Provisional Patent Application 61/923,658.

### FEDERALLY SPONSORED RESEARCH

None

### SEQUENCE LISTING

NONE

### BACKGROUND

The invention disclosed relates to sport-fishing and specifically is a fishing lure enhancement. The present invention serves to mimic the situation whereby a larger baitfish is pursuing a smaller baitfish. Often in nature this causes a response in a much larger fish to pursue and strike the larger baitfish. This is especially attractive to sport anglers as their preferred quarry is larger sport fish. There are many fishing lures known in the art; however, none of these lures allow a user to mimic a larger baitfish chasing a smaller baitfish while still enabling the user to cast the lure and retrieve it in a normal fashion. What is needed in the art is a fishing lure and enhancement that allow a user to mimic this natural activity.

### SUMMARY

The lure enhancement imitates a larger baitfish chasing multiple smaller bait fish by employing multiple semi-flexible chaser wires projecting forward from the nose region of a fishing lure and terminating into baitfish imitators. The chaser wires can be mounted directly into the nose of a fishing lure or can alternatively be mounted upon a central wire shaft that is connectable to a fishing lure. A central wire shaft is centrally located in between said chaser wires and is used for attachment to the nose of a fishing lure and for attachment of a fishing line. The central wire shaft is also used for attachment of the chaser wires onto its length along its base portion near the fishing lure.

The fishing lure enhancement can either be permanently molded into an existing fishing lure nose or into a lead jig-head and hook combination. It can also be made to be attachable and detachable from an existing fishing lure at a user's discretion through the use of an eyelet, fishing snap or a snap swivel or other similar connection. A simple hook can also be considered to be a fishing lure and can be attached directly to the fishing lure enhancement. The choice between permanent molding or an attachable embodiment of the lure enhancement will affect the way the fishing lure and enhancement travels through the water. Use of the lure enhancement in its attachable and detachable form gives a user more options in how the lure enhancement functions. Utilizing a swivel at the lure and enhancement connection will allow the lure enhancement to rotate in the water. Use of a swivel at both the lure nose and enhancement connection and the line connection will allow the chaser wires and baitfish imitators to rotate along the axis created by the taut fishing line moving through water. The fishing lure can vary in design, but should generally be one that swims through the water, imitates a fish predator, has a point of connection such as an installed eyelet, and one that has hooks.

The chaser wires can be of different length and diameter, but equal length is preferred for reasons of balance as the lure enhancement travels through water. The chaser wires are formed of semi-flexible stainless steel wire that maintains a straight linear configuration when force is not applied to it. The diameter of the chaser wires is dependent upon the size of the selected fishing lure and baitfish imitators by a user. The central wire shaft can be of varying length and diameter. The chaser wires project forward from the fishing lure and away from the central wire shaft and are arranged in a radial configuration around the central wire shaft and terminate in such a position so that there is substantially equal distance between each baitfish imitator in relation to each other and a substantially equal distance from each baitfish imitator to the central wire shaft. The connection of the chaser wires to the lure nose can be achieved by molding the chaser wires and central wire shaft within the body of the lure or by drilling into the nose of the lure and inserting the chaser wires and central wire shaft into the lure nose and permanently connecting by use of glue, epoxy, cement or some other suitable means to make the connection permanent. In another embodiment, the chaser wires and central wire shaft can be inserted into a lead jig-head and hook mold during the formation of the lead jig-head whereby a variety of soft plastic baits can be threaded onto the lead jig-head. Alternatively, the fishing lure enhancement can be formed separate and apart from a fishing lure by the attachment of the chaser wires at their ends to the central wire shaft by use of a crimp and solder.

The chaser wires can be located and attached to the central wire shaft at any location along the central wire shaft. The chaser wires can all be attached at one location on the central wire shaft or can be attached at different locations with respect to the other chaser wires. The chaser wires can be bent to create different presentations in the water. A baitfish imitator can also be added at any point along the length of the central wire shaft including at the crimp whereby the baitfish imitator is molded onto the crimp thereby hiding it from view.

The connection of the line to the central wire shaft and fishing lure instead of the bait imitators themselves enables the bait imitators to be pushed forward in the water as opposed to being pulled through the water. The baitfish imitators, by way of their connection to semi-flexible chaser wires, are able to move independently of each other because the chaser wires will flex in response to the water and associated currents around it. This creates a natural live action that is superior to other baitfish imitation lures because other baitfish imitation lures are merely pulled in tow by a line, thus being subdued to the forces exerted by the line, and are not allowed to freely move on their own in relation to their environment.

The chaser wires can be attached to a baitfish imitator by way of molding a baitfish imitator around the terminal end of each chaser wire. The chaser wires on their terminable ends should be bent in such a way so as to permanently fix any baitfish imitator mold that is installed, thereby preventing slippage of the baitfish imitator. Alternatively, the chaser wires can terminate into small loops for attachment of various types of baitfish imitators including blades, spinners, soft plastic and hard baitfish imitators via an eyelet or a swivel. Additionally, the chaser wires can terminate into a corkscrew or helical configuration to allow the insertion of soft plastic baitfish imitators that can be easily installed or removed by screwing or twisting the bait onto the chaser wire. In another embodiment, the each chaser wire can terminate into more than one bait imitator. An example of this can be achieved by use of a clevis with an attached spinner blade that slides onto the chaser wire behind a molded bait imitator. Located near the end of the chaser wire is a stop made of a small crimp that keeps the spinner and clevis in close proximity to the bait imitator.

The baitfish imitators can be made of a variety of materials such as soft or hard plastic, wood, metal and other suitable materials. The baitfish imitators can be made in numerous shapes, colors, hues and patterns. The baitfish imitators can also be made of lead, tungsten or other heavy metal that gives the lure enhancement a deep diving capacity to target fish at different depths in the water column. This solves the problem of trying to get certain fishing lures to deeper depths in an attractive way to fish. The baitfish imitators can also be spinners blades of various shapes such as Colorado™ and Willow™ blades among other commercially available blades use on fishing lures. Beads can also be placed along the length of both the chaser wires and the central wire shaft.

Due to the flexible nature of the chaser wires, the lure enhancement can be compressed toward the central wire shaft for compact storage thereby avoiding tangling with other fishing equipment in tackle boxes.

### DRAWINGS

FIG. 1 shows a side view of the lure enhancement.

FIG. 2 shows a front lateral view of a fishing lure and lure enhancement.

FIG. 3 shows a side perspective view of a fishing lure connected to the lure enhancement.

FIG. 4 shows a side perspective view of the lure enhancement molded into the body of a fishing lure.

FIG. 5 is a top plan view of fishing lure connected to the lure enhancement.

FIG. 6 is a side perspective view of lead jig-head and hook combination connected to the lure enhancement.

FIG. 7 is a side perspective view of the lure enhancement molded into the lead jig-head and hook combination.

FIG. 8 is a side perspective view of the lure enhancement with spinner blades attached to chaser wires.

FIG. 9 is a side perspective view of the lure enhancement with more than one bait imitator attached to each chaser wire.

FIG. 10 is a side perspective view of the lure enhancement with chaser wires terminating into corkscrews.

FIG. 11 is a side perspective view of the lure enhancement with a baitfish imitator also installed along the central wire shaft.

### DETAILED DESCRIPTION

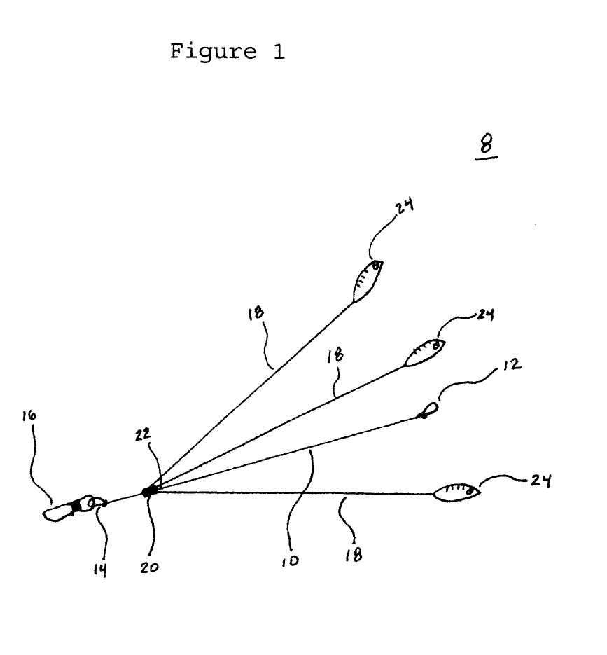

The invention is generally depicted in alternative embodiments in FIGS. 1-11, but may be embodied in various other forms. The principles and teachings of the invention, therefore, can be applied to numerous alternative variations. FIG. 1 is a side view of the fishing lure enhancement 8 depicting a central wire shaft 10 with a front loop 12 for the attachment of a fishing line and a base loop 14 for attachment to a fishing lure 26. Attached to the base loop 14 is a lure connector 16 that can be a snap swivel, safety snap, swivel or eyelet. The base of the central wire shaft 10 has located along its length chaser wires 18 attached by a crimp 20. Multiple chaser wires 18 are attached to the central main shaft 10 by a crimp 20 at a chaser wire junction 22. The chaser wires 18 terminate into baitfish imitators 24 that can be molded or inserted onto the end of the chaser wires 18. The chaser wires 18 are attached to the central main shaft 10 at their ends and project forward along the length of the central wire shaft 10 and away from the central wire shaft 10. The chaser wires 18 can be of different length and can be bent to a suitable position chosen by a user. The baitfish imitators 24 can be formed of molded hard plastic, soft plastic, metal, wood, glass, and other suitable materials. The baitfish imitators 24 can be painted in any variety of colors, hues, patterns and schemes with glitter, mylar, and holographic materials for purposes of presentation so as to mimic baitfish and otherwise elicit a strike response in a fish. Due to their flexible nature and because they are not directly attached to the pulling force of a user, the chaser wires 18 are free to flex and move around at the force of increased speed of retrieval by a user, various different currents present in a body of water, and/or locating and retrieving the fishing lure 26 enhancement 8 in close proximity to physical objects located in the water. The chaser wires 18 on their terminable ends should be bent in such a way so as to permanently fix any baitfish imitator 24 mold that is installed around them, thereby preventing slippage of the baitfish imitator 24. The baitfish imitators 24 in an alternate embodiment can be made of different densities of metal thereby allowing different rates of depth of travel of the fishing lure 26 enhancement 8.

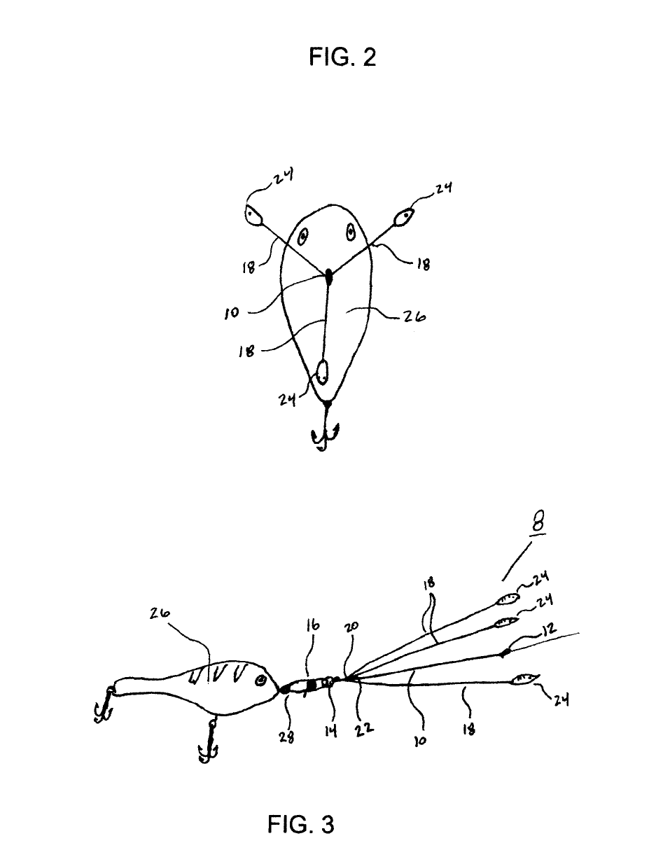

FIG. 2 is a front lateral view of a fishing lure 26 connected to the enhancement 8 depicting the arrangement of the chaser wires 18 arranged in a radial configuration around the central wire shaft 10. Said chaser wires 18 terminate in such a position so that there is substantially equal distance between each baitfish imitator 24 in relation to each other and a substantially equal distance from each baitfish imitator 24 to the central wire shaft 10.

FIG. 3 is a side view depicting a fishing lure 26 and enhancement connection 28.

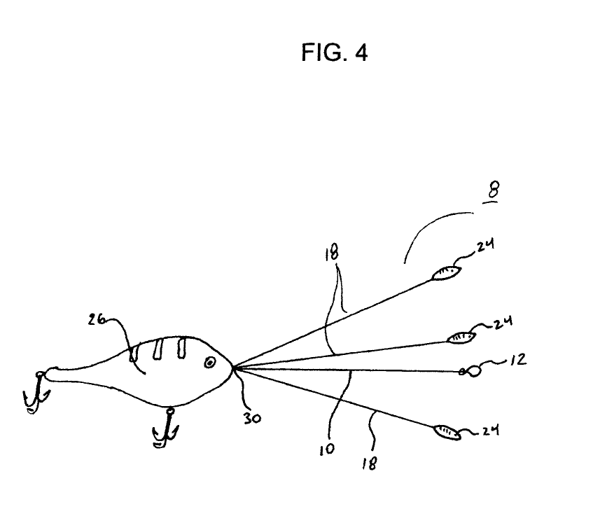

FIG. 4 is a side view depicting a fishing lure 26 with the central wire shaft 10 and the chaser wires 18 molded into the fishing lure 26 thereby creating a fishing lure and enhancement junction 30 whereby the central wire shaft 10 and chaser wires 18 project forward out of the nose of the fishing lure 26. The chaser wires 18 terminate into baitfish imitators 24.

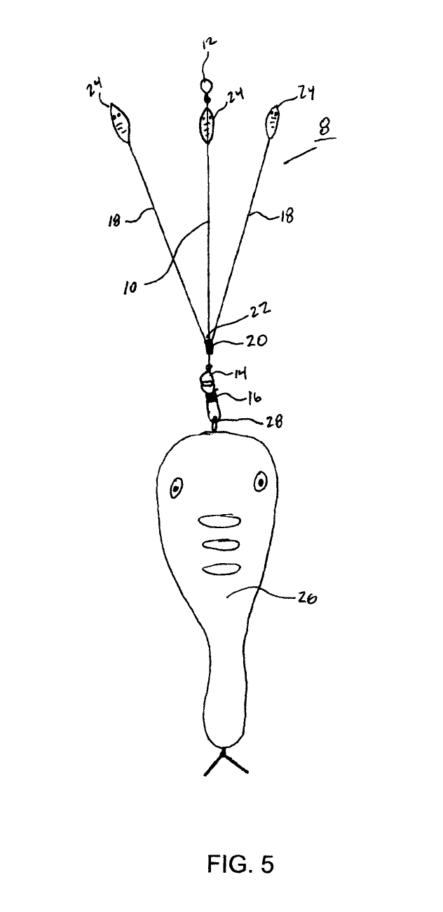

FIG. 5 is a top plan view depicting the fishing lure 26 and enhancement 8 connection 28 and the position of the baitfish imitators 24 on the terminal ends of the chaser wires 18 and their location with respect to the central wire shaft 10.

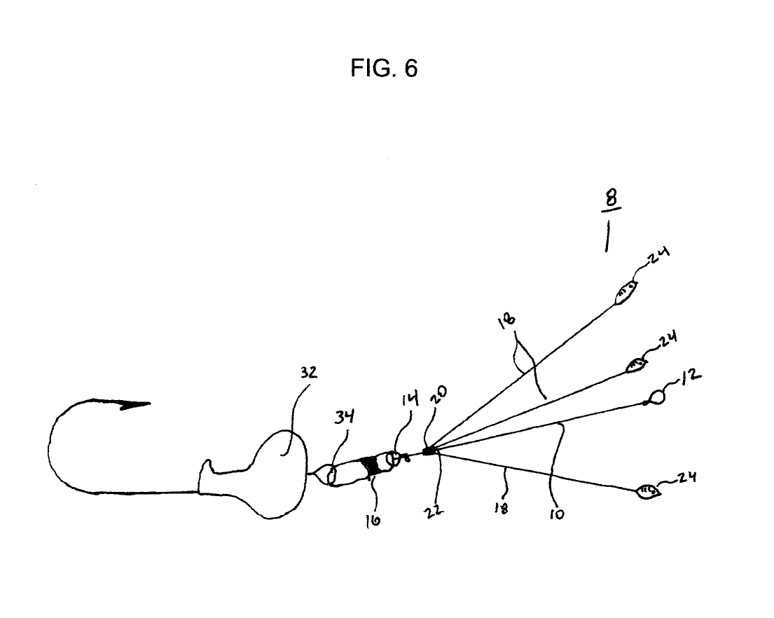

FIG. 6 is a side view of a jig-head 32 connected to the lure enhancement 8 creating a jig head and enhancement connection 34. The use of jig-head 32 in conjunction with the lure enhancement 8 gives a user a multitude of different choices when choosing a bait to install upon the jig head 32 body.

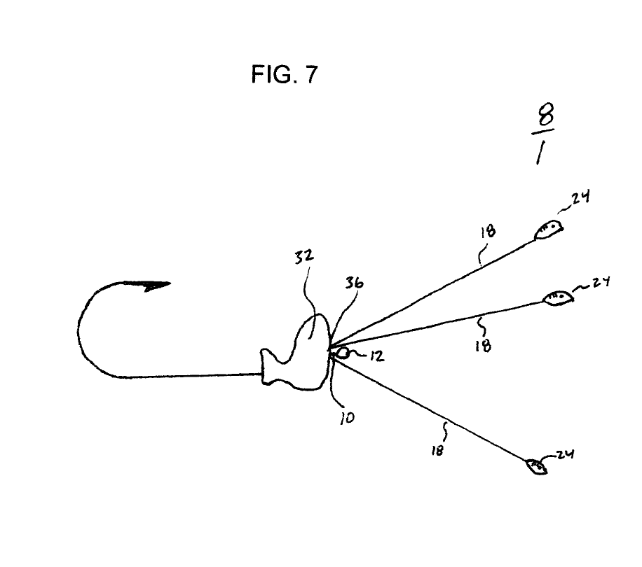

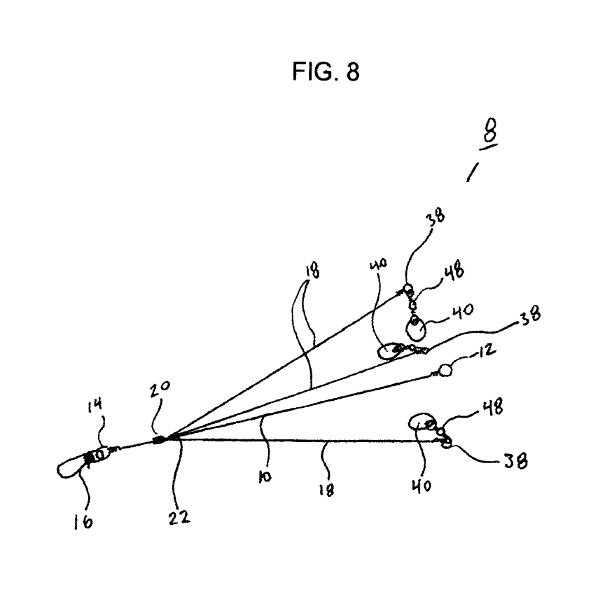

FIG. 7 is a side view of a jig-head 32 with the lure enhancement 8 molded into the jig head 32 creating a jig-head and lure enhancement junction 36.

FIG. 8 shows the enhancement 8 with chaser wires 18 terminating into loops 38 for connection of spinner imitators 40 by way of a swivel 48.

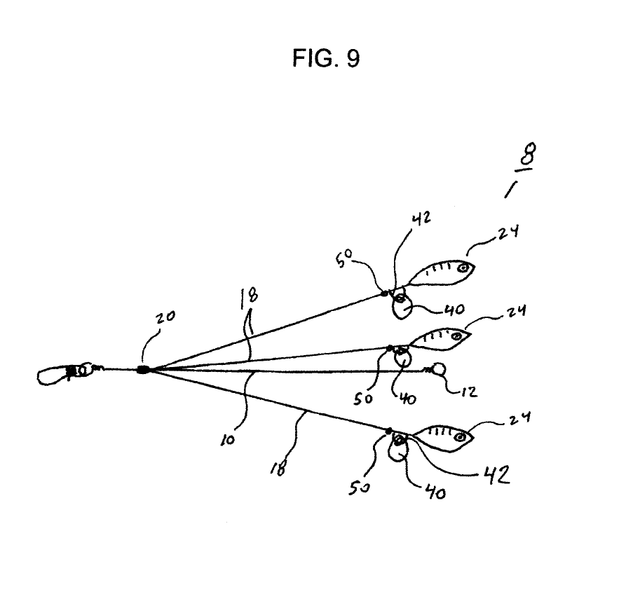

FIG. 9 depicts the lure enhancement 8 with chaser wires 18 that terminate into molded bait imitators 24. The chaser wires 18 also have a clevis 42 installed onto the chaser wire 18 with spinner imitators 40 installed onto the clevis 42. There is also installed on each chaser wire, substantially near the bait imitator 24 to keep the clevis 42 and spinner imitator 40 in a location near the bait imitator 24, a crimp stop 50 formed of a crimp upon the chaser wire 18. The crimp stop 50 keeps the clevis 42 and spinner imitator 40 close to the bait imitator 24 so they act in unison to attract fish. The crimp stop 50 is a band of metal that is installed around the chaser wires 18 and the central wire shaft 10 by use of a crimping tool. Welding or soldering means of connection of the chaser wires 18 onto the central wire shaft 10 could be used in an alternate embodiment.

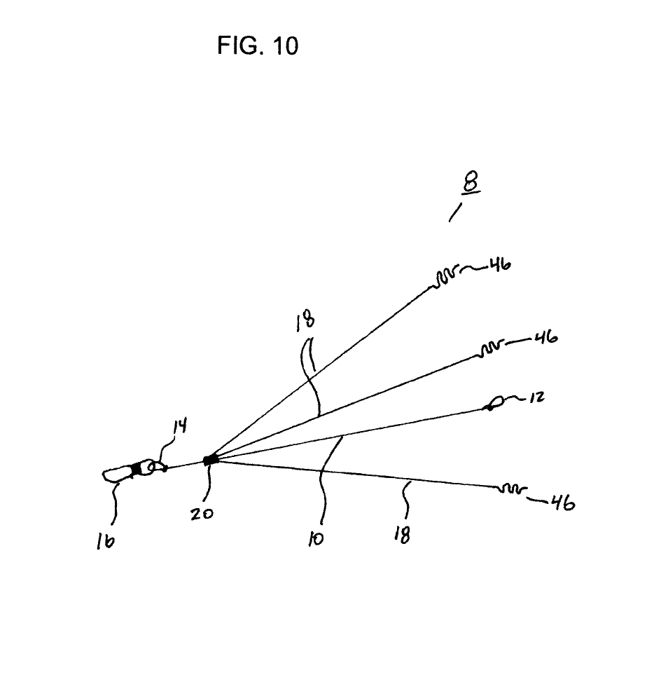

FIG. 10 depicts the lure enhancement 8 with chaser wires 18 ending into terminal corkscrews 46 for purposes of attaching various small soft plastic baits by way of threading the baits onto the terminal corkscrews 46.

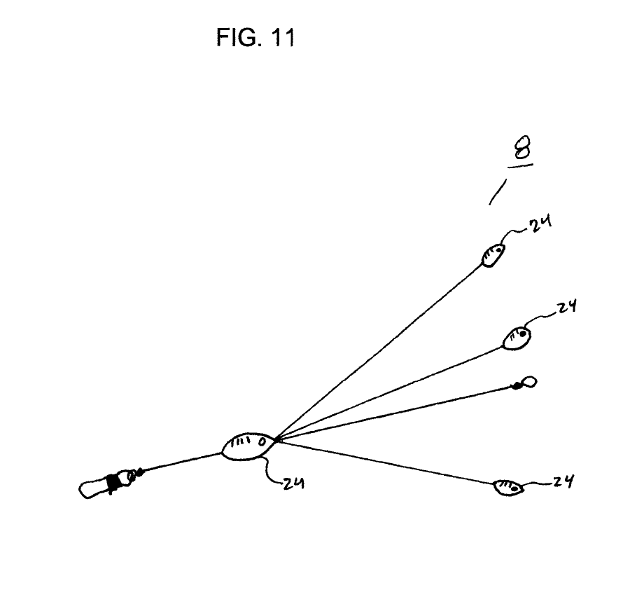

FIG. 11 depicts the lure enhancement 8 with a baitfish imitator 24 located along the central wire shaft 10. The baitfish imitator 24 can be molded virtually anywhere along the central wire shaft 10. As shown in FIG. 11, the baitfish imitator 24 is molded over and on top of the crimp 20 and the chaser wire junction 22 so as to hide them and create a more attractive presentation to fish. More than one bait fish imitator 24 can be located onto the central wire shaft 10.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

What is claimed is:

1. A fishing lure enhancement, comprising;
a central wire shaft;
a front loop on said central wire shaft for connection to a fishing line;
a base loop on said central wire shaft for connection to a lure connector for releasable connection with a fishing lure;
more than one chaser wires installed on the length of said central wire shaft;
a crimp formed around said chaser wires where they install upon the central wire shaft;
said chaser wires projected in a direction forward and away from said base loop on said central wire shaft, whereby each said chaser wire creates an acute angle with said central wire shaft at the point of installation of said chaser wire onto said central wire shaft; and
at least one baitfish imitator installed onto each of said chaser wires.

2. The fishing lure enhancement of claim 1 wherein the lure connector has a swivel incorporated therein.

3. The fishing lure enhancement of claim 2 wherein the baitfish imitators are molded around the ends of the chaser wires.

4. The fishing lure of claim 3 wherein a chaser wire stop is installed on each chaser wire behind the baitfish imitator so as to accommodate a clevis between said chaser wire stop and said baitfish imitator further comprising a spinner imitator attached to each said clevis.

5. The fishing lure enhancement of claim 2 wherein the baitfish imitator on each said chaser wire is a spinner imitator attached to said chaser wire terminal loops by use of a swivel.

6. The fishing lure of claim 2 wherein the terminal ends of said chaser wires terminate into a corkscrew adapted for receiving soft baitfish imitators.

7. The fishing lure of claim 2 wherein the crimp stop has molded around it a baitfish imitator.

8. The fishing lure enhancement of claim 1 wherein the baitfish imitators are molded around the ends of the chaser wires.

9. The fishing lure enhancement of claim 8 wherein a chaser wire stop is installed on each chaser wire behind the baitfish imitator so as to accommodate a clevis between said chaser wire stop and said baitfish imitator further comprising a spinner imitator attached to each said clevis.

10. The fishing lure enhancement of claim 1 wherein the baitfish imitator on each said chaser wire is a spinner imitator attached to said chaser wire terminal loops by use of a swivel.

11. The fishing lure of claim 1 wherein the terminal ends of said chaser wires terminate into a corkscrew adapted for receiving soft baitfish imitators.

12. The fishing lure of claim 1 wherein the crimp stop has molded around it a baitfish imitator.

13. A fishing lure, comprising:
a lure body having a leading portion;
hooks attached to said lure body;
a central wire shaft installed into the head of the lure body;
a front loop on said central wire shaft for connection to a fishing line;
more than one chaser wires installed on the length of said central wire shaft;
a crimp formed around said chaser wires where they install upon the central wire shaft;
said chaser wires projected in a direction forward and away from the fishing lure on said central wire shaft, whereby each said chaser wire creates an acute angle with said central wire shaft at the point of installation of said chaser wire onto said central wire shaft; and
at least one baitfish imitator installed onto each of said chaser wires.

14. The fishing lure of claim 13 wherein the baitfish imitators are molded around the ends of the chaser wires.

15. The fishing lure of claim 13 wherein a chaser wire stop is installed on each chaser wire behind the baitfish imitator so as to accommodate a clevis between said chaser wire stop and said baitfish imitator further comprising a spinner imitator attached to each said clevis.

16. The fishing lure enhancement of claim 13 wherein the baitfish imitator on each said chaser wire is a spinner imitator attached to said chaser wire terminal loop by use of a swivel.

17. The fishing lure of claim 13 wherein the terminal ends of said chaser wires terminate into a corkscrew adapted for receiving soft baitfish imitators.

18. The fishing lure of claim 13 wherein the baitfish imitators are made of metal.

19. A fishing lure, comprising:
a lure body having a leading portion;
hooks attached to said lure body;
a central wire shaft installed into the head of the lure body;
a front loop on said central wire shaft for connection to a fishing line;
more than one chaser wires installed into the body of the fishing lure at the head such that they surround the central wire shaft;
said chaser wires projected in a direction forward and away from the fishing lure whereby each said chaser wire creates an acute angle with said central wire shaft at the point of installation of said chaser wire into the lure body and the central wire shaft; and
at least one baitfish imitator installed onto each of said chaser wires.

20. The fishing lure enhancement of claim 1 wherein the baitfish imitators are made of metal.
